(19) United States
(12) Patent Application Publication
(10) Pub. No.: US 2024/0226618 A1
(43) Pub. Date: Jul. 11, 2024

(54) ADJUSTABLE PADDING FOR A SAFETY HARNESS

(71) Applicant: CHECKMATE LIFTING & SAFETY LTD, Kent (GB)

(72) Inventors: Judd J. Perner, Missouri City, TX (US); Luis D. Herrera, Houston, TX (US); Andres Rubalcava, Spring, TX (US)

(73) Assignee: CHECKMATE LIFTING & SAFETY LTD, Kent (GB)

(21) Appl. No.: 18/204,760

(22) Filed: Jun. 1, 2023

Related U.S. Application Data
(60) Provisional application No. 63/438,364, filed on Jan. 11, 2023.

(51) Int. Cl. A62B 35/00

(52) U.S. Cl. CPC A62B 35/0031

(57) ABSTRACT

An adjustable safety harness comprises first and second shoulder straps, a waist strap, and pad assemblies. A shoulder pad assembly comprises a base pad portion, first and second shoulder pad portions, and first and second extension portions. The first and second shoulder pad portions extend from the base pad portion. The first and second extension portions are selectively operatively connected to the first and second shoulder pad portions. A waist pad assembly comprises a base waist pad portion and first and second side pad portions. The first and second side pad portions are selectively operatively connected to the base waist pad portion. At least a portion of each of the first and second side pad portions includes at least two sizing indicators configured and arranged to provide selective adjustment of the adjustable padding to one of at least two sizes.

### BACKGROUND

Fall protection equipment is commonly used to reduce a likelihood of a fall and/or serious injuries associated with a fall, particularly by users who perform tasks at heights or are at risk of falling. Generally, lifelines or lanyards typically interconnect anchorage structures and safety harnesses donned by users. The lifelines or lanyards allow the users to move and perform tasks while being connected to the anchorage structures. Should a user fall, the fall protection equipment generally limits the distance the user falls.

Traditionally, safety harnesses are comprised of fixed padding sets that do not allow the user to modify or adjust the area of padding to the user's preference. Even though a harness could fit the user, the padding coverage could not be to the user's preference due to standard sizing convention. For example, a user may prefer the shoulder padding to be positioned in a desired position relative to the user's chest, and a user may prefer the waist belt padding to be positioned in a desired position relative to the user's waist. Current safety harness designs do not offer adjustability on the shoulder padding or the waist belt padding and, therefore, do not offer accommodations for varying physical differences among users donning the same sizes of safety harnesses. Comfort is an important feature for proper fit and safety.

For the reasons stated above and for other reasons stated below, which will become apparent to those skilled in the art upon reading and understanding the present specification, there is a need in the art for adjustable padding for safety harnesses.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, adjustable padding for a safety harness comprises a base pad portion, first and second shoulder pad portions, and first and second extension portions. The first shoulder pad portion extends from a first side of the base pad portion and the second shoulder pad portion extends from a second side of the base pad portion. The first extension portion is selectively operatively connected to the first shoulder pad portion in a desired one of at least two positions via a first releasable fastener and the second extension portion is selectively operatively connected to the second shoulder pad portion in a desired one of at least two positions via a second releasable fastener.

In one embodiment, adjustable padding for a safety harness comprises a base waist pad portion and first and second side pad portions. The first side pad portion is selectively operatively connected to a first side of the base waist pad portion in a desired one of at least two positions via a first releasable fastener and the second side pad portion is selectively operatively connected to a second side of the base waist pad portion in a desired one of at least two positions via a second releasable fastener. At least a portion of each of the first side pad portion and the second side pad portion includes at least two sizing indicators configured and arranged to provide selective adjustment of the adjustable padding to one of at least two sizes.

In one embodiment, an adjustable safety harness comprises first and second shoulder straps, a waist strap, a shoulder pad assembly, and a waist pad assembly. The shoulder pad assembly comprises a base pad portion, first and second shoulder pad portions, and first and second extension portions. The first shoulder pad portion extends from a first side of the base pad portion and the second shoulder pad portion extends from a second side of the base pad portion. The first and second shoulder pad portions are configured and arranged to engage the first and second shoulder straps. The first extension portion is selectively operatively connected to the first shoulder pad portion in a desired one of at least two positions via a first releasable fastener and the second extension portion is selectively operatively connected to the second shoulder pad portion in a desired one of at least two positions via a second releasable fastener. The waist pad assembly comprises a base waist pad portion and first and second side pad portions configured and arranged to engage the waist strap. The first side pad portion is selectively operatively connected to a first side of the base waist pad portion in a desired one of at least two positions via a first releasable fastener and the second side pad portion is selectively operatively connected to a second side of the base waist pad portion in a desired one of at least two positions via a second releasable fastener. At least a portion of each of the first side pad portion and the second side pad portion includes at least two sizing indicators configured and arranged to provide selective adjustment of the adjustable padding to one of at least two sizes.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front view of a base pad portion of an embodiment shoulder padding assembly constructed in accordance with the principles of the present invention;

FIG. 2 is a rear view of the base pad portion shown in FIG. 1;

FIG. 3 is a front view of an extension portion for use with the base pad portion of the embodiment shoulder padding assembly shown in FIG. 1 constructed in accordance with the principles of the present invention;

FIG. 4 is a rear view of the extension portion shown in FIG. 3;

FIG. 5 is a front view of a portion of a safety harness to which the base pad portion and the extension portion (shoulder padding assembly) shown in FIGS. 1 and 3 are operatively connected;

FIG. 6 is a rear view of a portion of the safety harness shown in FIG. 5 to which the shoulder padding assembly is operatively connected;

FIG. 7 is a front view of a shoulder pad portion of the base pad portion shown in FIG. 1 to which the extension portion shown in FIG. 3 is operatively connected in a first position;

FIG. 8 is a front view of the shoulder pad portion and the extension portion shown in FIG. 7 in a second position;

FIG. 9 is a front view of the shoulder pad portion and the extension portion shown in FIG. 7 in a third position;

FIG. 10 is a front view of a safety harness to which the shoulder padding assembly and a waist padding assembly are connected;

FIG. 11 is a front exploded view of an embodiment waist padding assembly constructed in accordance with the principles of the present invention;

FIG. 12 is a rear exploded view of the waist padding assembly shown in FIG. 11 without webbing connectors;

FIG. 13 is a front view of the waist padding assembly shown in FIG. 11;

FIG. 14 is a rear view of the waist padding assembly shown in FIG. 11;

FIG. 15 is a perspective view of a portion of the waist padding assembly shown in FIG. 11;

FIG. 16 is a perspective view of a portion of the waist padding assembly shown in FIG. 11;

FIG. 17 is a front view of a portion of the waist padding assembly shown in FIG. 11 with a side pad portion in a first position;

FIG. 18 is a rear view of a portion of a base portion of the waist padding assembly shown in FIG. 11; and

FIG. 19 is a front view of the side pad portion shown in FIG. 17.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a padding assembly that allows the user the option to not only adjust their harness chassis (webbing) but also their padding coverage proximate their shoulders and/or waist. In one example, the shoulder pad assembly has adjustable extension portions that can be adjusted outward relative to a base pad portion to provide more shoulder padding coverage, and the waist pad has two adjustable side pad portions that are fully removable but are held together via a releasable fastener for adjustment purposes for user preference. Therefore, not only can the webbing be adjusted but the padding can be adjusted. Although both the shoulder pad assembly and the waist pad assembly are shown and described, it is recognized that one or both assemblies can be used. For example, a safety harness can include one or both types of adjustable padding assemblies.

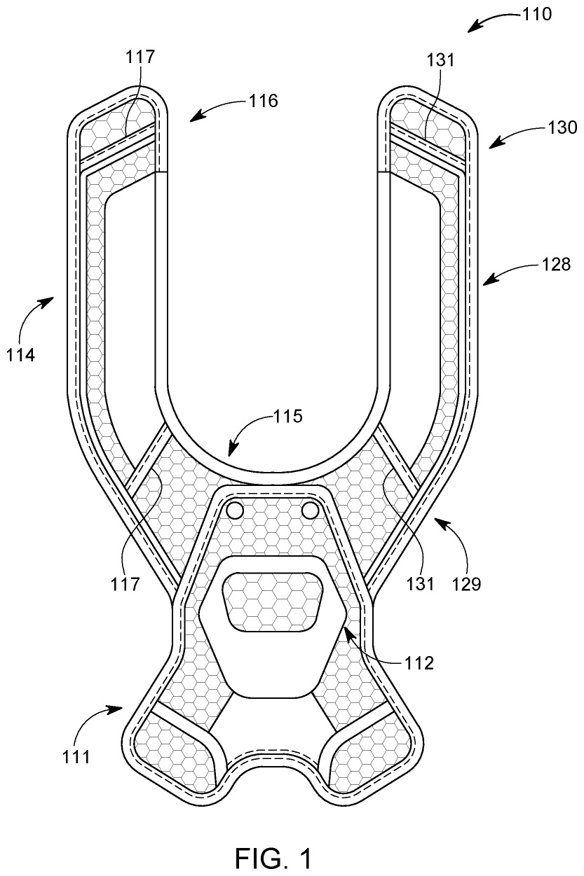

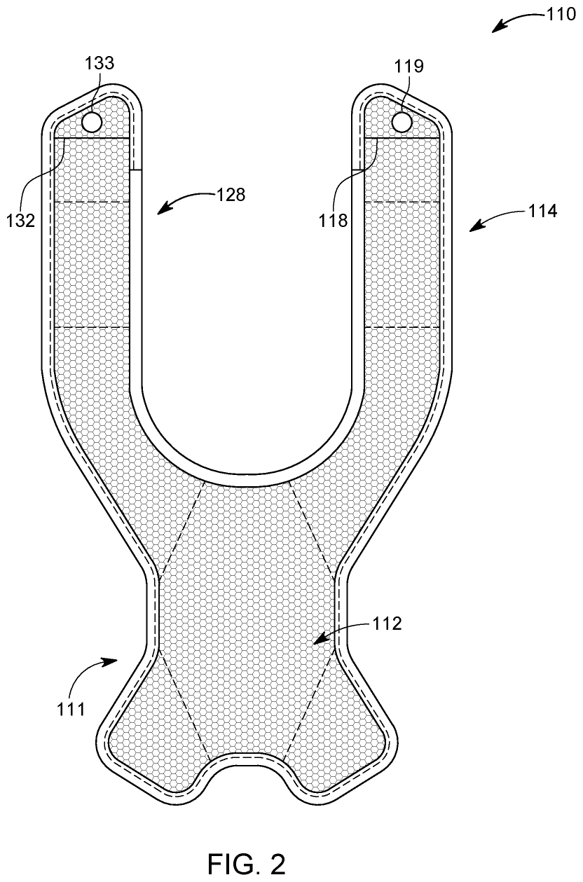

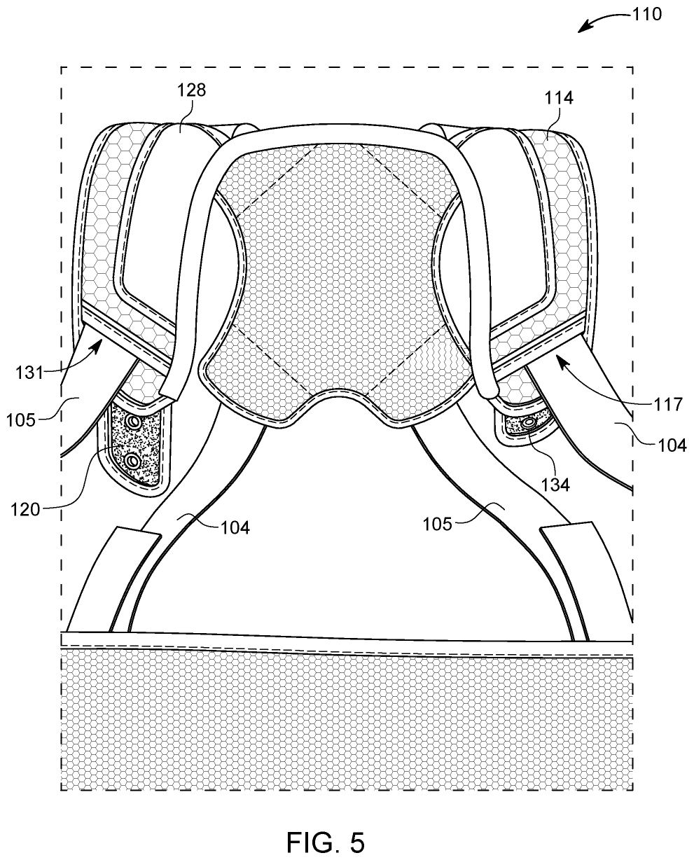

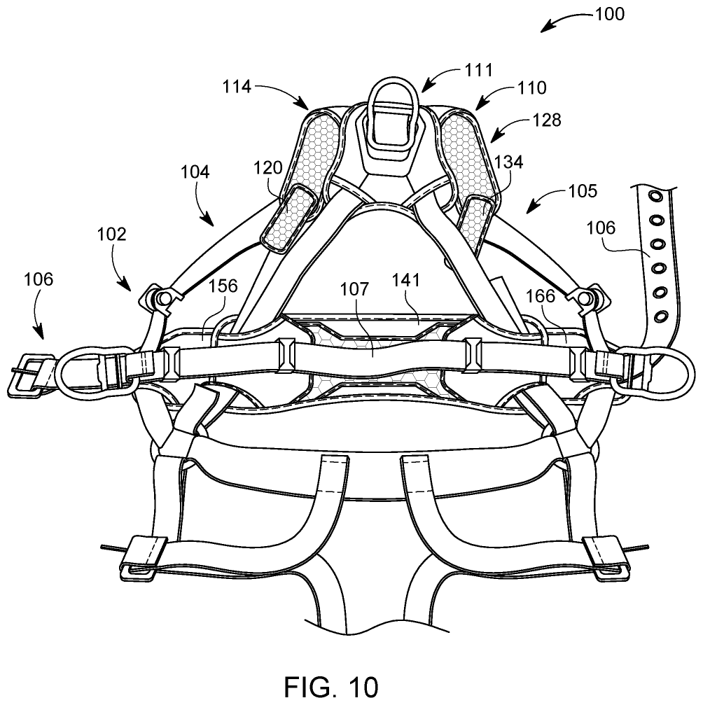

In one embodiment, illustrated in FIGS. 1-9, a shoulder padding assembly 110 includes a base pad portion 111 from which a first shoulder pad portion 114 extends from a first side of the base pad portion 111 and a second shoulder pad portion 128 extends from a second side of the base pad portion 111. The first and second sides are preferably on opposing sides of the base pad portion 111 and the base pad portion includes a dorsal pad portion 112 configured and arranged to receive a dorsal D-ring of a safety harness, as illustrated in FIG. 10. As illustrated in FIG. 5, a portion of an example adjustable safety harness 100 includes harness webbing 102 forming a first shoulder strap 104 and a second shoulder strap 105 that are routed through the shoulder padding assembly 110. The first shoulder strap 104 includes a first webbing channel 117, formed between layers of the first shoulder strap 104, extending from proximate its proximal end 115 to its distal end 116 on its front side, and the second shoulder strap 105 includes a second webbing channel 131, formed between layers of the second shoulder strap 105, extending from proximate its proximal end 129 to its distal end 130 on its front side. The first and second webbing channels 117 and 131 are configured and arranged to slidably receive the first and second shoulder straps 104 and 105. Preferably, the layers forming the channels are made of ripstop connected along their sides by piping.

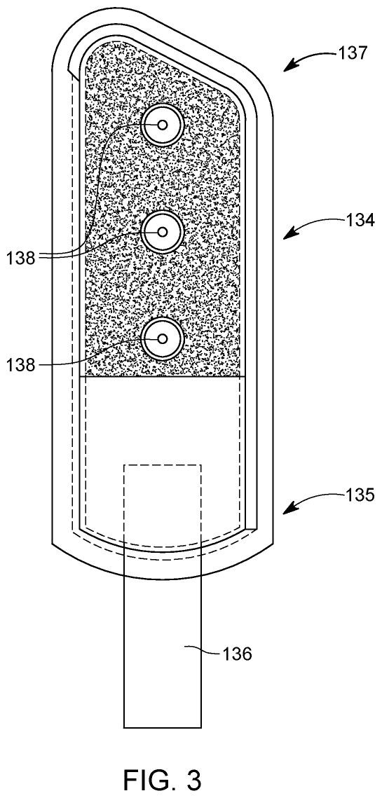

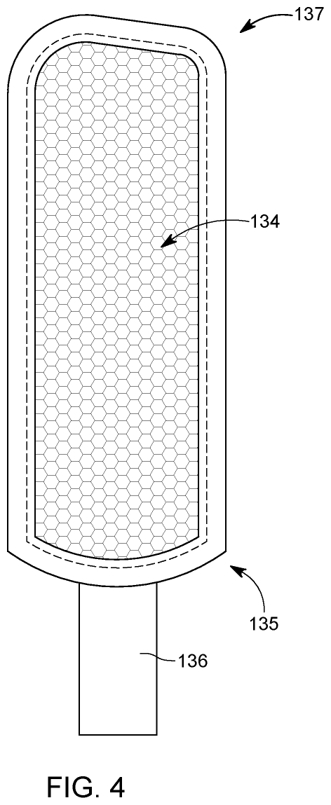

A first extension portion 120 is selectively operatively connected to the first shoulder pad portion 114 in a desired one of at least two positions via a first releasable fastener 119/124, and a second extension portion 134 is selectively operatively connected to the second shoulder pad portion 128 in a desired one of at least two positions via a second releasable fastener 133/138. The second extension portion 134 is shown in FIGS. 3 and 4. In this example, the releasable fasteners are snaps, and the second extension portion 134 includes 2 or more snap portions, preferably 3 snap portions, which allows the second extension portion 134 to be connected to the second shoulder pad portion 128 in any one of 2 or more, preferably 3, positions relative to the second shoulder pad portion 128. The snap portions are preferably positioned proximate a distal end 137 of the second extension portion 134 and can extend into an intermediate portion of the second extension portion 134, and an optional tether 136 can be connected to a proximal end 135 of the second extension portion 134. The first extension portion 120 is preferably similarly constructed.

The portions of the first and second releasable fasteners 119 and 133 connected to the first and second shoulder padding portions 114 and 128, preferably on the rear side, are proximate the distal ends 116 and 130, and they are configured and arranged to mate with select mating portions of the first and second releasable fasteners 124 and 138 connected to the first and second extension portions 120 and 134. The first and second releasable fasteners 119/124 and 133/138 are preferably selected from the group consisting of snaps and hook and loop fasteners. If hook and loop fastener is used, one or more sections of hook and/or loop can be connected to the shoulder pad portions and/or the extension portions to provide either defined or undefined positions.

The distal ends 116 and 130 of the first and second shoulder pad portions 114 and 128, preferably proximate the rear side, preferably include respective first and second padding channels 118 and 132 configured and arranged to slidably receive portions of the respective first and second extension portions 120 and 134 including the proximal ends 121 and 135. An optional first tether 122 preferably operatively connects the proximal end 121 of the first extension portion 120 to the first shoulder pad portion 114 and an optional second tether 136 preferably operatively connects the proximal end 135 of the second extension portion 134 to the second shoulder pad portion 128. The first and second tethers 122 and 136, along with the proximal ends 121 and 135, are preferably contained within the respective first and second padding channels 118 and 132. Each of the first and second tethers 122 and 136 can be any suitable material, such as an elastic material, with a first end secured to the shoulder pad portion and a second end secured to the extension portion.

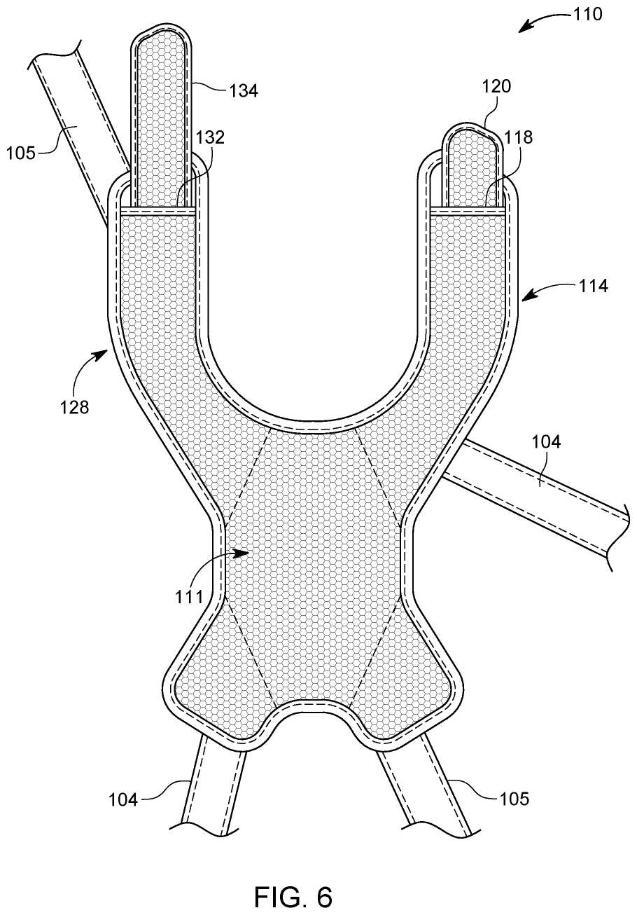

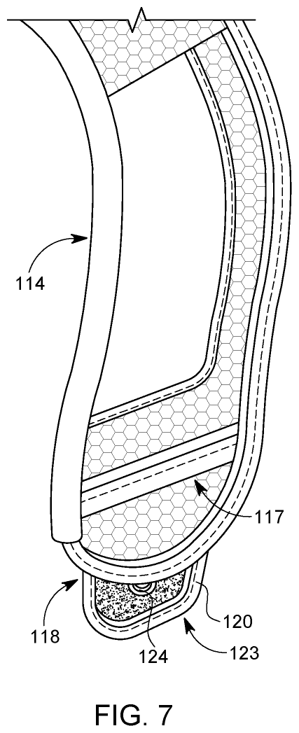

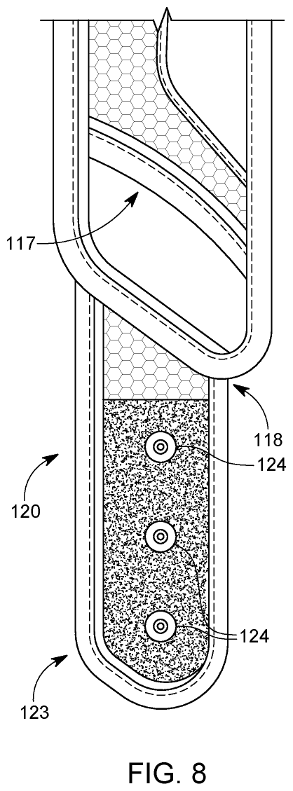

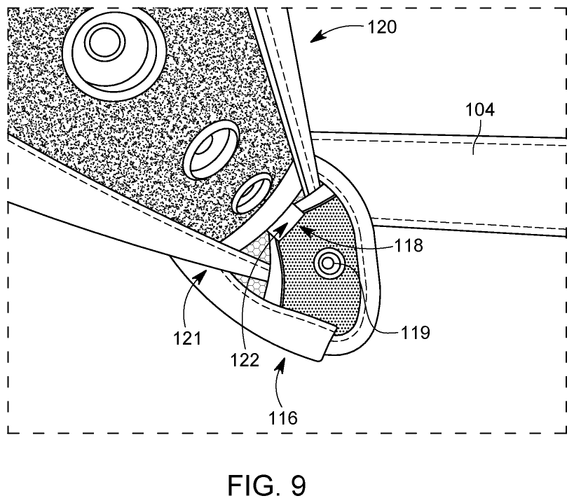

FIG. 6 illustrates the first extension 120 in one position relative to the first shoulder pad portion 114 and the second extension 134 in another position relative to the second shoulder pad portion 128. The extension portions can be in similar or different positions as desired by the user. FIGS. 7 and 8 illustrate the first extension 120 in different positions relative to the first shoulder pad portion 114, with FIG. 7 showing a connected position and FIG. 8 showing a disconnected position with regard to the releasable fasteners. FIG. 9 illustrates how the tether 122 interconnects the first extension 120 and the first shoulder pad portion 114.

In operation, the user will preferably adjust the harness straps to fit properly as is known in the art. Then, the user will position and connect the extensions relative to the shoulder pad portions to enhance fit and comfort.

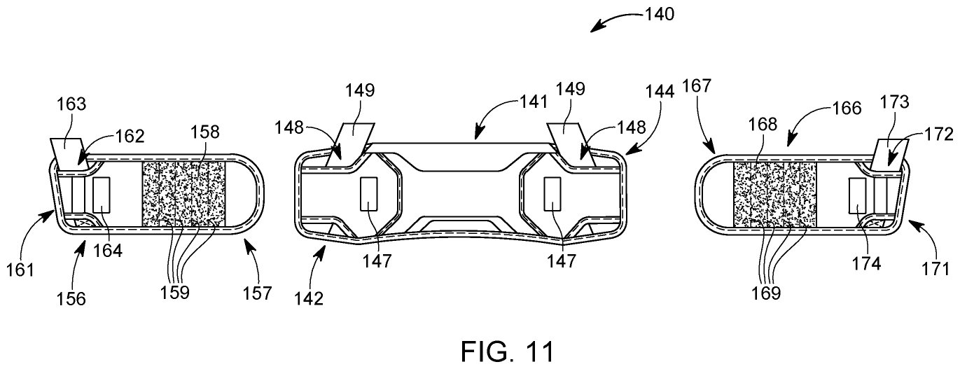

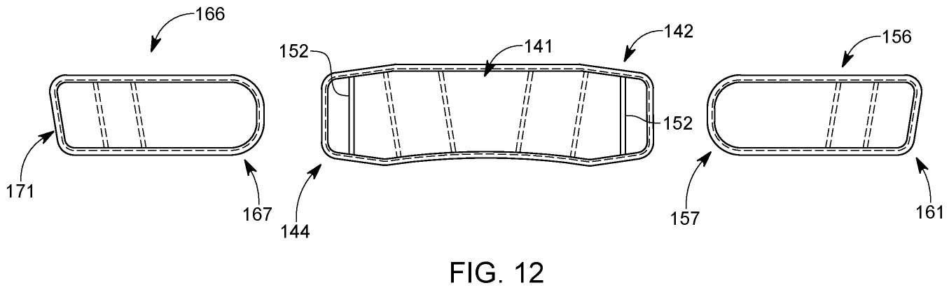

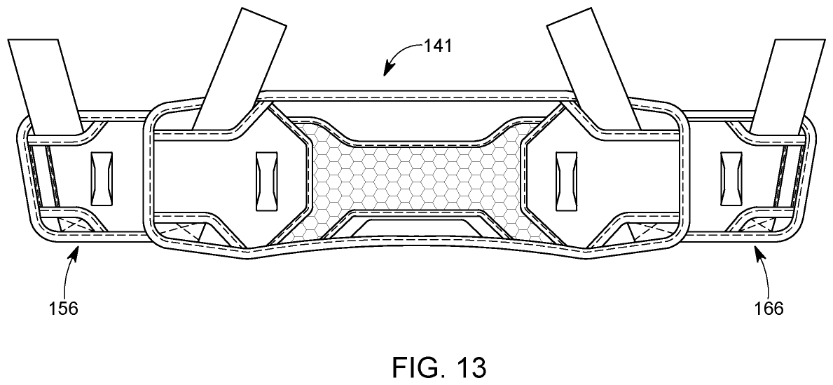

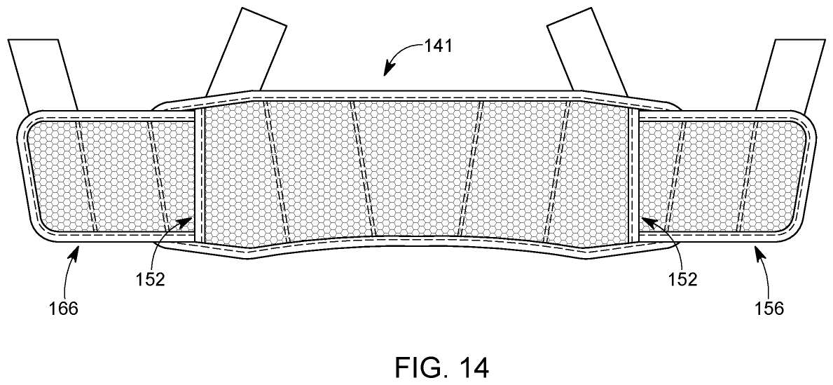

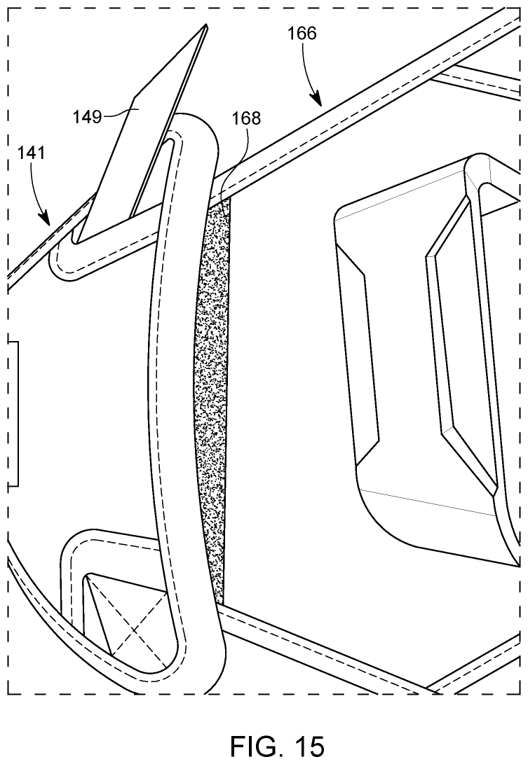

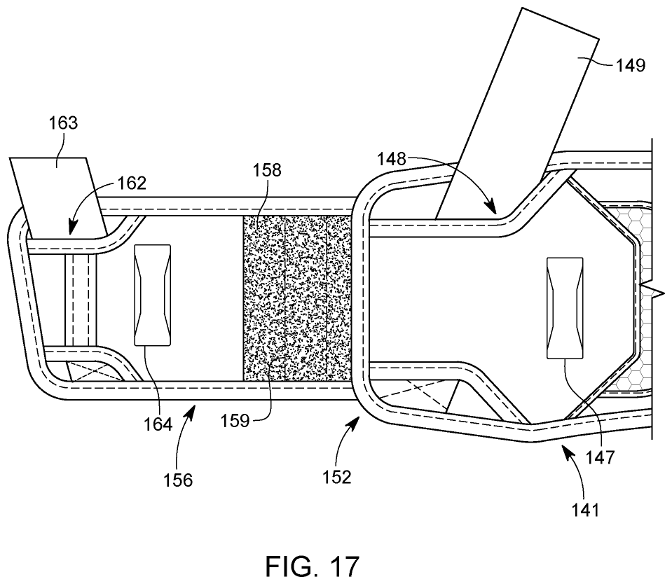

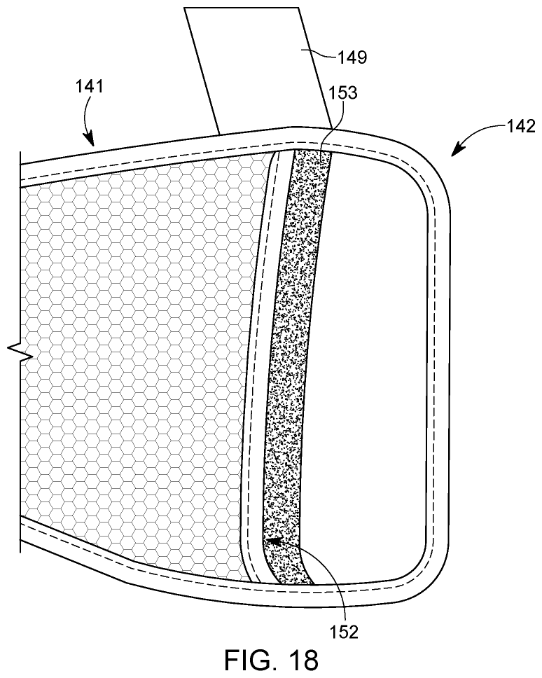

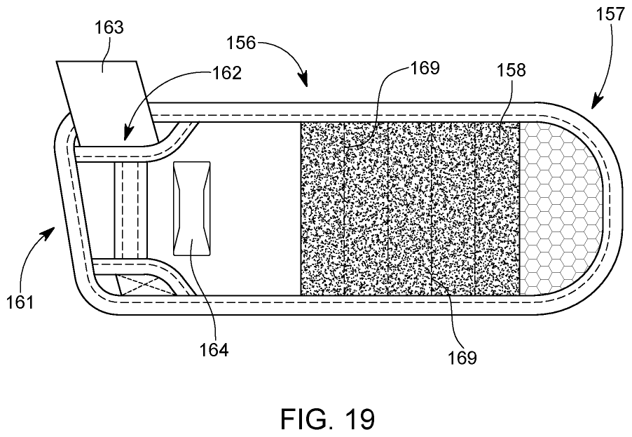

In one embodiment, illustrated in FIGS. 11-19, a waist padding assembly 140 includes a base waist pad 141 having a first side 142 to which a first side pad portion 156 is selectively operatively connected in a desired one of at least two positions, optionally via a first releasable fastener 153/158, and having a second side 144 to which a second side pad portion 166 is selectively operatively connected in a desired one of at least two positions, optionally via a second releasable fastener 154/168. The first and second side pad portions 156 and 166 are configured and arranged to be disconnectable from the base waist pad 141.

The base waist pad 141 is generally rectangular and configured and arranged to extend from proximate hip to hip and across the back of the user. The base waist pad 141 includes a webbing loop 147 proximate each end that are configured and arranged to also slidably receive the waist strap 106. The distal ends of the base waist pad 141 can include lateral webbing channels 148 configured and arranged to receive shoulder straps 104 and 105 of the safety harness. Optionally, harness webbing connectors 149, which are segments of webbing, can be positioned within the lateral webbing channels 148 and secured to the base waist pad 141 for ease of assembly of the safety harness. During assembly, rather than insert the shoulder straps through the lateral webbing channels 148 and securing them thereto, the shoulder straps can be secured to the segments of webbing.

The first side pad portion 156 includes a proximal end 157 configured and arranged to be operatively connected to the base waist pad 141 and to include the optional releasable fastener 158 and sizing indicators 159. There are preferably at least two sizing indicators, more preferably at least four sizing indicators, configured and arranged to provide selective adjustment of the adjustable padding to one of at least two sizes. The sizing indicators can be stitching or any other suitable indicators. A distal end 161 includes an optional lateral webbing channel 162 and a webbing loop 164. The lateral webbing channel 162 is configured and arranged to receive shoulder straps 104 and 105 of the safety harness. Optionally, a harness webbing connector 163, which is a segment of webbing, can be positioned within the lateral webbing channel 162 and secured to the side extension for ease of assembly of the safety harness. During assembly, rather than insert the shoulder strap through the lateral webbing channel and securing it thereto, the shoulder strap can be secured to the segment of webbing. The webbing loop 164 is configured and arranged to receive the waist strap 106 of the safety harness.

Similarly, the second side pad portion 166 includes a proximal end 167 configured and arranged to be operatively connected to the base waist pad 141 and to include the optional releasable fastener 168 and sizing indicators 169. There are preferably at least two sizing indicators, more preferably at least four sizing indicators, configured and arranged to provide selective adjustment of the adjustable padding to one of at least two sizes. The sizing indicators can be stitching or any other suitable indicators. A distal end 171 includes an optional lateral webbing channel 172 and a webbing loop 174. The lateral webbing channel 172 is configured and arranged to receive shoulder straps 104 and 105 of the safety harness. Optionally, a harness webbing connector 173, which is a segment of webbing, can be positioned within the lateral webbing channel 172 and secured to the side extension for ease of assembly of the safety harness. During assembly, rather than insert the shoulder strap through the lateral webbing channel and securing it thereto, the shoulder strap can be secured to the segment of webbing. The webbing loop 174 is configured and arranged to receive the waist strap 106 of the safety harness.

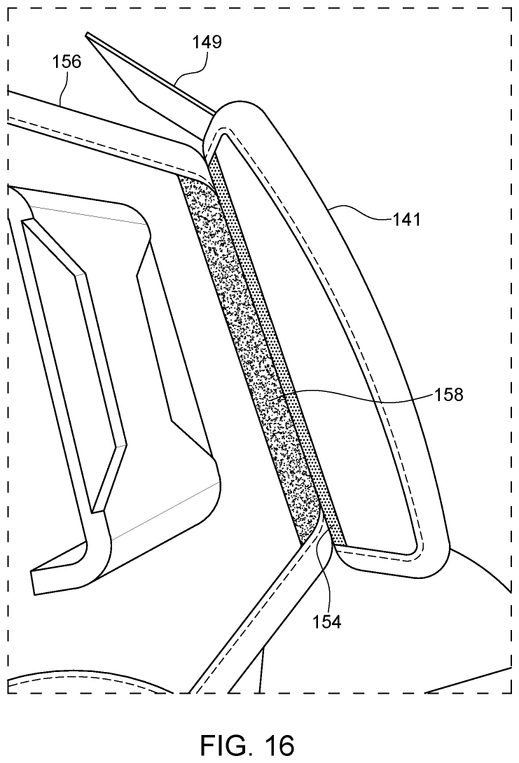

On the rear side of the base waist pad 141, a padding channel 152 is formed by layers of the pad. In this example, the first side 1420 of the base waist pad 141 portion preferably includes a first padding channel 152 configured and arranged to slidably receive a portion of the first side pad portion 156, and the second side 144 of the base waist pad portion 141 preferably includes a second channel 152 configured and arranged to slidably receive a portion of the second side pad portion 166. The first and second channels 152 can be separate or in communication. Optional releasable fasteners 153/158 and 154/168 can be used to selectively connect the side pad portions 156 and 166 to the base waist pad 141 in one of several positions. In one example, the base waist pad 141 includes a fastener portion 158 (as shown in FIG. 16) and a fastener portion 168 proximate the respective openings into the padding channel 152. These are configured and arranged to releasably connect to the releasable fasteners 158 and 168 of the side extensions and can be used to keep the side pad portions in the desired positions relative to the base waist pad.

The first and second releasable fasteners are preferably hook and loop fasteners with the base waist pad portion including one of hook or loop portions of the hook and loop fasteners and the first and second side pad portions including another of the hook or loop portions of the hook and loop fasteners. In one example, the first and second side pad portions include the loop portions of the hook and loop fasteners and the sizing indicators are positioned on the loop portions. In one example, the sizing indicators are stitching in the loop portions.

The positioning belt 107 of the safety harness includes webbing with a D-ring operatively connected to each end. During assembly of the safety harness, the webbing of the positioning belt is threaded through the webbing loops 164, 147, 174 and is slidably connected, which could result in one of the side pad portions separating from the base pad portion in an asymmetrical position. The harness waist strap 106 is threaded through the D-ring slots of the positioning belt and each of the webbing loops 164, 147, 174 before being operatively connected to the webbing of the harness, as known in the art. Preferably, the waist strap 106 of the safety harness includes webbing with a buckle on one end and grommets on the other end so that it can be selectively secured to accommodate different users.

In operation, the user will preferably adjust the harness straps to fit properly as is known in the art. Then, the user will position and optionally connect the side extensions relative to the base waist pad to enhance fit and comfort.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. Adjustable padding for a safety harness, comprising:
a base pad portion;
a first shoulder pad portion extending from a first side of the base pad portion;
a second shoulder pad portion extending from a second side of the base pad portion;
a first extension portion selectively operatively connected to the first shoulder pad portion in a desired one of at least two positions via a first releasable fastener; and
a second extension portion selectively operatively connected to the second shoulder pad portion in a desired one of at least two positions via a second releasable fastener.

2. The adjustable padding of claim 1, wherein distal ends of the first and second shoulder pad portions include respective first and second channels configured and arranged to slidably receive portions of the respective first and second extension portions.

3. The adjustable padding of claim 1, further comprising a first tether operatively connecting the first extension portion to the first shoulder pad portion and a second tether operatively connecting the second extension portion to the second shoulder pad portion.

4. The adjustable padding of claim 3, wherein distal ends of the first and second shoulder pad portions include respective first and second channels configured and arranged to slidably receive portions of the respective first and second extension portions, and wherein the first and second tethers are contained within the respective first and second channels.

5. The adjustable padding of claim 3, wherein each of the first and second tethers is an elastic material with a first end secured to the shoulder pad and a second end secured to the extension portion.

6. The adjustable padding of claim 1, wherein the first and second releasable fasteners are selected from the group consisting of snaps and hook and loop fasteners.

7. The adjustable padding of claim 1, wherein the first and second sides are on opposing sides of the base pad portion and the base pad portion includes a dorsal pad portion configured and arranged to receive a dorsal D-ring of the safety harness.

8. Adjustable padding for a safety harness, comprising:
a base waist pad portion;
a first side pad portion selectively operatively connected to a first side of the base waist pad portion in a desired one of at least two positions via a first releasable fastener; and
a second side pad portion selectively operatively connected to a second side of the base waist pad portion in a desired one of at least two positions via a second releasable fastener;
wherein at least a portion of each of the first side pad portion and the second side pad portion includes at least two sizing indicators configured and arranged to provide selective adjustment of the adjustable padding to one of at least two sizes.

9. The adjustable padding of claim 8, wherein the first side of the base waist pad portion includes a first channel configured and arranged to slidably receive a portion of the first side pad portion, and wherein the second side of the base waist pad portion includes a second channel configured and arranged to slidably receive a portion of the second side pad portion.

10. The adjustable padding of claim 9, wherein the first and second releasable fasteners are hook and loop fasteners, the base waist pad portion including one of hook or loop portions of the hook and loop fasteners and the first and second side pad portions including another of the hook or loop portions of the hook and loop fasteners.

11. The adjustable padding of claim 8, wherein the at least two sizing indicators are stitching.

12. The adjustable padding of claim 11, wherein the first and second side pad portions include the loop portions of the hook and loop fasteners and the stitching is positioned on the loop portions.

13. The adjustable padding of claim 8, wherein the first and second side pad portions are configured and arranged to be disconnected from the base waist pad portion.

14. An adjustable safety harness, comprising:
a first shoulder strap and a second shoulder strap;
a waist strap;
a shoulder pad assembly, comprising:
a base pad portion;
a first shoulder pad portion extending from a first side of the base pad portion configured and arranged to engage the first shoulder strap;
a second shoulder pad portion extending from a second side of the base pad portion configured and arranged to engage the second shoulder strap;
a first extension portion selectively operatively connected to the first shoulder pad portion in a desired one of at least two positions via a first releasable fastener; and
a second extension portion selectively operatively connected to the second shoulder pad portion in a desired one of at least two positions via a second releasable fastener;
a waist pad assembly, comprising:
a base waist pad portion;
a first side pad portion selectively operatively connected to a first side of the base waist pad portion in a desired one of at least two positions via a first releasable fastener; and
a second side pad portion selectively operatively connected to a second side of the base waist pad portion in a desired one of at least two positions via a second releasable fastener;
wherein the base waist pad portion and the first and second side pad portions are configured and arranged to engage the waist strap;
wherein at least a portion of each of the first side pad portion and the second side pad portion includes at least two sizing indicators configured and arranged to provide selective adjustment of the adjustable padding to one of at least two sizes.

15. The adjustable safety harness of claim 14, wherein distal ends of the first and second shoulder pad portions include respective first and second channels configured and arranged to slidably receive portions of the respective first and second extension portions.

16. The adjustable safety harness of claim 14, further comprising a first tether operatively connecting the first extension portion to the first shoulder pad portion and a second tether operatively connecting the second extension portion to the second shoulder pad portion.

17. The adjustable safety harness of claim 16, wherein distal ends of the first and second shoulder pad portions include respective first and second channels configured and arranged to slidably receive portions of the respective first and second extension portions, wherein each of the first and second tethers has a first end secured to the shoulder pad and a second end secured to the extension portion, and wherein the first and second tethers are contained within the respective first and second channels.

18. The adjustable safety harness of claim 14, wherein the first side of the base waist pad portion includes a first channel configured and arranged to slidably receive a portion of the first side pad portion, wherein the second side of the base waist pad portion includes a second channel configured and arranged to slidably receive a portion of the second side pad portion, wherein the first and second releasable fasteners are hook and loop fasteners, the base waist pad portion including one of hook or loop portions of the hook and loop fasteners and the first and second side pad portions including another of the hook or loop portions of the hook and loop fasteners.

19. The adjustable safety harness of claim 14, wherein the at least two sizing indicators are stitching.

20. The adjustable safety harness of claim 19, wherein the first and second releasable fasteners are hook and loop fasteners, wherein the first and second side pad portions include loop portions of the hook and loop fasteners and the stitching is positioned on the loop portions.

21. The adjustable safety harness of claim 14, wherein the first and second side pad portions are configured and arranged to be disconnected from the base waist pad portion.
